(19) United States
(12) Patent Application Publication
(10) Pub. No.: US 2013/0243988 A1
(43) Pub. Date: Sep. 19, 2013

(54) FLAME-RETARDANT, FLEXIBLE RESIN COMPOSITION AND RESIN TUBE AND INSULATED WIRE USING SAME

(71) Applicants: Taro Fujita, Osaka-shi (JP); Hayato Aoi, Sennan-gun (JP)

(72) Inventors: Taro Fujita, Osaka-shi (JP); Hayato Aoi, Sennan-gun (JP)

(73) Assignees: SUMITOMO ELECTRIC FINE POLYMER, INC., Sennan-gun, Osaka (JP); SUMITOMO ELECTRIC INDUSTRIES, LTD., Osaka-shi, Osaka (JP)

(21) Appl. No.: 13/883,287

(22) PCT Filed: Jul. 2, 2012
(86) PCT No.: PCT/JP2012/066840

§ 371 Date: May 3, 2013

(30) Foreign Application Priority Data
Jul. 14, 2011 (JP) 2011-155595

(51) Int. Cl. C08K 3/34; H01B 7/295; C08L 23/08; H01B 3/30; C08L 23/28

(52) U.S. Cl. CPC C08K 3/34; H01B 3/307; C08L 23/286; C08L 23/08; H01B 7/295
USPC 428/36.9; 524/450; 174/110 SR

(57) ABSTRACT

Provided are a flame-retardant, flexible resin composition having high mechanical strength, flexibility, heat resistance, oil resistance, flame retardancy, and processability with a good balance between the properties and a resin tube and an insulated wire having an insulating coating, the resin tube and the insulating coating being formed by using the flame-retardant, flexible resin composition as a material.

The flame-retardant, flexible resin composition contains a resin component that mainly contains chlorinated polyethylene, and 0.5 to 20 parts by mass of a zeolite-based compound relative to 100 parts by mass of the chlorinated polyethylene, and is cross-linked by irradiation with ionizing radiation. The resin tube and the insulated wire having an insulating coating are formed by using the flame-retardant, flexible resin composition as a material.

### TECHNICAL FIELD

The present invention relates to a flame-retardant, flexible resin composition used in a resin tube, an insulating coating of an insulated wire, and the like that are used in automobiles, electrical equipment, etc. The present invention also relates to a resin tube and an insulated wire formed by using the flame-retardant, flexible resin composition.

### BACKGROUND ART

In automobiles and electrical equipment, resin tubes such as a heat-shrinkable tube and an insulating tube are used in order to protect bundled wires thereinside in an insulating manner. The resin tubes require high mechanical strength, flexibility, heat resistance, oil resistance, flame retardancy, and processability. Therefore, in order to form these resin tubes, a resin composition that can provide these properties with a good balance between the properties has been desired. Insulated wires (also including insulated cables) used as wiring in automobiles and electrical equipment also require high mechanical strength, flexibility, heat resistance, oil resistance, flame retardancy, and processability. Accordingly, a resin composition that can provide the above properties with a good balance between the properties has also been desired for a resin composition used for forming an insulating coating of an insulated wire.

PTL 1 discloses a flame-retardant resin composition obtained by blending hindered phenol-based and thioether-based antioxidants with a mixture of 90% to 30% by weight of a polyolefin resin and 10% to 70% by weight of chlorinated polyethylene, and cross-linking the resulting composition. It is described that this flame-retardant resin composition is useful as a cable insulation material, that is, an insulating coating material of an insulated wire because the flame-retardant resin composition is good in terms of heat aging resistance, flexibility (plasticity), and flame retardancy, and because precipitation (so-called blooming) on a surface of the composition does not occur during storage of the resin composition.

PTL 2 discloses a resin composition obtained by blending a chlorine-containing polymer such as chlorinated polyethylene with (a) a zeolite-based compound, (b) a vulcanizing agent, and, if necessary, (c) a vulcanization accelerator. It is described that the (a) zeolite-based compound used in this resin composition may be natural zeolite, A-type, X-type, or Y-type synthetic zeolite, sodalite, natural or synthetic mordenite, Zeolite Socony Mobil (ZSM)-5, or a metal substitution product thereof.

### CITATION LIST

### Patent Literature

PTL 1: Japanese Unexamined Patent Application Publication No. 5-295179
PTL 2: Japanese Unexamined Patent Application Publication No. 2000-63685

### SUMMARY OF INVENTION

### Technical Problem

However, although PTL 1 describes that the flame-retardant resin composition described therein is good in terms of heat aging resistance, the flame-retardant resin composition actually exhibits unsatisfactory heat resistance. It is believed that this is because the chlorinated polyethylene contained in the flame-retardant resin composition undergoes dehydrochlorination at a high temperature and then undergoes oxidative decomposition, and thus scission of the main chain occurs.

Regarding the resin composition described in PTL 2, it is difficult to increase a linear extrusion speed. Accordingly, in the case where the resin composition is used for, for example, forming a resin tube or an insulating coating, the processability of the resin composition is low, resulting in a problem of an increase in the process cost. More specifically, this resin composition is a material containing a vulcanizing agent, and a cross-linking reaction proceeds when the resin composition is heated to 150° C. or higher. Thus, it is necessary to suppress the extrusion temperature to lower than 150° C. However, when the linear extrusion speed is increased at a temperature of lower than 150° C., the appearance of the extruded product is degraded, and thus it is difficult to process the resin composition at a high linear extrusion speed. Therefore, a resin composition that has higher heat resistance and that is good in terms of mechanical strength, flexibility, oil resistance, flame retardancy, and processability has been desired.

An object of the present invention is to provide a resin composition that meets this requirement, specifically, to provide a flame-retardant, flexible resin composition having high mechanical strength, flexibility, heat resistance, oil resistance, flame retardancy, and processability with a good balance between the properties. Another object of the present invention is to provide a resin tube formed by using this flame-retardant, flexible resin composition as a material and an insulated wire having an insulating coating formed by using this flame-retardant, flexible resin composition as a material.

### Solution to Problem

As a result of studies conducted in order to achieve the above objects, the inventors of the present invention found that a flame-retardant, flexible resin composition having high mechanical strength, flexibility, heat resistance, oil resistance, flame retardancy, and processability with a good balance between the properties is obtained by cross-linking, by irradiation with ionizing radiation, a resin composition containing chlorinated polyethylene and a zeolite-based compound in a particular composition range. This finding led to the completion of the present invention.

An invention according to claim 1 provides a flame-retardant, flexible resin composition containing a resin component that mainly contains chlorinated polyethylene, and 0.5 to 20 parts by mass of a zeolite-based compound relative to 100 parts by mass of the chlorinated polyethylene, the resin composition being cross-linked by irradiation with ionizing radiation.

Chlorinated polyethylene is known as a thermoplastic elastomer that is good in terms of mechanical strength, processability, oil resistance, and flexibility and also exhibits flame retardancy because it contains chlorine. The flame-retardant, flexible resin composition of the present invention combines good mechanical strength with high extrusion processability, oil resistance, flexibility, and flame retardancy, and thus it mainly contains chlorinated polyethylene. Chlorinated polyethylene is classified into crystalline chlorinated polyethylene, semicrystalline chlorinated polyethylene, and amorphous chlorinated polyethylene. Any of these types of chlorinated polyethylene may be used in the present invention.

The zeolite-based compound contained in the resin composition of the present invention is a mineral containing silica (silicon dioxide) and alumina (aluminum oxide) as main components and is represented by a general formula M_{2/x}O.Al₂O₃.ySiO₂.nH₂O (where M represents an alkali metal or an alkaline earth metal, x represents 1 or 2, y represents 2 to 10, and n represents zero or a positive number). Examples of the zeolite-based compound include natural zeolite, which is a mineral formed by solidification of a volcanic rock, synthetic (artificial) zeolite, sodalite, natural and synthetic mordenite, ZSM-5, and metal substitution products thereof. For example, a zeolite-based compound which is represented by the chemical structural formula (1) below and in which M in the general formula is Ca or Mg is preferably used because the compound has particularly high heat resistance.

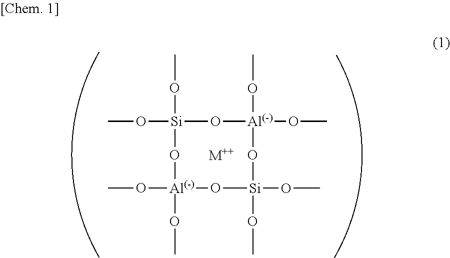

The flame-retardant, flexible resin composition of the present invention contains 0.5 to 20 parts by mass of the zeolite-based compound relative to 100 parts by mass of chlorinated polyethylene. By adding the zeolite-based compound to chlorinated polyethylene, it is possible to obtain a resin composition which has high heat resistance and in which the mechanical strength does not tend to decrease even when the resin composition is stored at a high temperature. It is believed that chlorinated polyethylene undergoes dehydrochlorination at a high temperature and then undergoes oxidative decomposition, and thus scission of the main chain occurs, thereby decreasing the mechanical strength. It is believed that, however, the decrease in the mechanical strength is suppressed because the zeolite-based compound adsorbs the generated hydrochloric acid (hydrogen chloride gas) due to its good adsorption performance.

Furthermore, even when the zeolite-based compound is added within the above composition range, a problem such as foaming does not occur in an extrusion process of the resin composition for forming a resin tube or an insulating coating. That is, the high processability of chlorinated polyethylene is maintained. The use of the zeolite-based compound suppresses foaming to suppress infiltration of oil, and thus oil resistance is also improved.

When the amount of zeolite-based compound added is less than 0.5 parts by mass relative to 100 parts by mass of chlorinated polyethylene, the effect of improving heat resistance is not sufficiently obtained. On the other hand, when the amount of zeolite-based compound added exceeds 20 parts by mass, mechanical strengths such as a tensile strength and a tensile elongation at break become insufficient, and oil resistance and processability are also decreased. Furthermore, the 100% modulus may also be out of the standard range and thus flexibility may also be insufficient. Accordingly, the effects aimed by the present invention are not obtained.

The flame-retardant, flexible resin composition of the present invention is obtained by irradiating a resin composition with ionizing radiation to cross-link a resin, the resin composition being prepared by incorporating a zeolite-based compound in chlorinated polyethylene. By cross-linking the resin, a resin composition having a high mechanical strength is obtained.

An invention according to claim 2 provides the flame-retardant, flexible resin composition according to claim 1, in which the zeolite-based compound is a synthetic zeolite represented by a general formula M_{2/x}.O.Al₂O₃.ySiO₂.nH₂O (where M represents an alkaline earth metal, x represents 1 or 2, y represents 2 to 10, and n represents zero or a positive number).

An example of the synthetic zeolite is an artificial zeolite having a regular chemical structure and obtained by chemically treating ash containing silica and alumina as main components with an alkali or the like at a high temperature and a high pressure. Another example thereof is the synthetic zeolite produced by the method described in PTL 2 (paragraph 0025). An artificial zeolite having an adsorption performance higher than that of natural zeolite is obtained by adjusting the composition and reaction conditions. Any of A-type, X-type, and Y-type synthetic zeolites may also be used.

By using such an artificial zeolite in which an alkaline earth metal is held, a resin composition that combines higher extrusion processability with higher heat resistance can be prepared.

An invention according to claim 3 provides the flame-retardant, flexible resin composition according to claim 2, in which the zeolite-based compound is a calcined zeolite.

The term “calcined zeolite” (also referred to as “active zeolite”) refers to an activated zeolite obtained by dehydrating (calcining) the zeolite-based compound described above by heating so that water is not substantially contained. Examples of the method for preparing a calcined zeolite include the methods described in PTL 2 (paragraph 0026), namely, a method in which a zeolite-based compound is dehydrated by heating at a temperature of 100° C. or higher in a dry air or nitrogen stream and a method in which, when chlorinated polyethylene is kneaded with other components, a zeolite-based compound is charged in the mixture and exposed to a kneading temperature of 140° C. to 200° C., thereby activating the zeolite-based compound.

By using such a calcined zeolite, a resin composition that combines higher extrusion processability with higher heat resistance can be prepared.

An invention according to claim 4 provides the flame-retardant, flexible resin composition according to any one of claims 1 to 3, in which the resin component further contains a polyolefin resin selected from ethylene/α-olefin copolymers, the α-olefin being a polar monomer, in an amount of 20 parts by mass or less relative to 100 parts by mass of the total of the chlorinated polyethylene and the polyolefin resin.

A resin component of the flame-retardant, flexible resin composition of the present invention mainly contains chlorinated polyethylene. Herein, the phrase “mainly contain” means both the case where the resin component contains only chlorinated polyethylene and the case where the resin component contains chlorinated polyethylene and other resin components incorporated within a range that does not impair the gist of the present invention. In the case where the resin component contains other resin components, chlorinated polyethylene is blended in an amount of at least 50 parts by mass or more and preferably 80 parts by mass or more relative to 100 parts by mass of the total of the chlorinated polyethylene and the other resin components.

The flame-retardant, flexible resin composition according to claim 4 contains, in addition to the composition described above, a polyolefin resin selected from ethylene/α-olefin copolymers, the α-olefin being a polar monomer, in an amount of 20 parts by mass or less relative to 100 parts by mass of the total of the chlorinated polyethylene and the polyolefin resin. By blending this polyolefin resin, heat resistance and flexibility of the resin composition are further improved. However, when the amount of polyolefin resin blended exceeds 20 parts by mass relative to 100 parts by mass of the total of the chlorinated polyethylene and the polyolefin resin, oil resistance is decreased, and a flame-retardant, flexible resin composition that achieves the object of the present invention is not obtained.

Examples of the polyolefin resin selected from ethylene/α-olefin copolymers, the α-olefin being a polar monomer, include ethylene/vinyl acetate copolymers (EVA). A commercially available ethylene/vinyl acetate copolymer having a trade name of, for example, EVAFLEX EV360 (manufactured by Du pont-Mitsui Polychemicals Co., Ltd.) can be used as the ethylene/vinyl acetate copolymer.

The flame-retardant, flexible resin composition of the present invention may further contain, in addition to the above composition, a flame retardant such as antimony trioxide, other polyolefin resins, a filler, an antioxidant, a lubricant, a color pigment, and the like as long as the gist of the present invention is not impaired.

The flame-retardant, flexible resin composition of the present invention is obtained by irradiating a resin composition with ionizing radiation such as an electron beam or gamma rays, the resin composition being prepared by mixing the above composition by a common method, to cross-link chlorinated polyethylene (and a polyolefin resin in some cases). As the radiation, electron beam irradiation, which is widely industrially used and which can perform cross-linking at a low cost, is preferable. The exposure dose of the electron beam is preferably about 30 to 500 kGy. The electron beam irradiation can be conducted by a common method using known electron beam irradiation means that is usually used in, for example, cross-linking of a resin.

An invention according to claim 5 provides a resin tube produced by forming the flame-retardant, flexible resin composition according to any one of claims 1 to 4 into a tube. Since this resin tube is a formed body of the flame-retardant, flexible resin composition of the present invention, the resin tube has high mechanical strength, flexibility, heat resistance, oil resistance, and flame retardancy with a good balance between the properties. Thus, the resin tube is suitably used as a heat-shrinkable tube or an insulating tube for protecting bundled wires inside an automobile or electrical equipment in an insulating manner. An example of a method for forming the resin composition into a tube is extrusion molding. The resin composition of the present invention can be formed into a tube by the same method and under the same conditions as in the case of forming a known resin tube.

In the production of a resin tube of the present invention, it is preferable to employ a method including preparing a resin composition having the composition described above, forming the resin composition into a tube by extrusion molding, and then irradiating the tube with ionizing radiation. Since the resin composition can be easily formed before the irradiation with ionizing radiation and formed at a high extrusion speed, high productivity can be achieved.

An invention according to claim 6 provides an insulated wire including an insulating coating composed of the flame-retardant, flexible resin composition according to any one of claims 1 to 4. Since the insulating coating of this insulated wire is composed of the flame-retardant, flexible resin composition of the present invention, the insulating coating has high mechanical strength, flexibility, heat resistance, oil resistance, and flame retardancy with a good balance between the properties and is suitably used for wiring in an automobile or electrical equipment. The insulating coating can be formed by the same method as used in the formation of an insulating coating of a common insulated wire. Note that the term “insulated wire” also covers an insulated cable.

In the production of the insulated wire of the present invention, it is preferable to employ a method including preparing a resin composition having the composition described above, processing the resin composition by extrusion so as to cover a conductor, and then irradiating the resulting wire with ionizing radiation. Since the insulating coating can be easily performed before the irradiation with ionizing radiation and the insulating coating can be performed at a high speed, high productivity can be achieved.

### Advantageous Effects of Invention

The flame-retardant, flexible resin composition of the present invention can provide a formed product having high mechanical strength, flexibility, heat resistance, oil resistance, and flame retardancy, and is good in terms of processability. Accordingly, a resin tube and an insulated wire of the present invention that are formed using this flame-retardant, flexible resin composition also have high mechanical strength, flexibility, heat resistance, oil resistance, and flame retardancy.

### DESCRIPTION OF EMBODIMENTS

Next, embodiments for carrying out the present invention will be described. However, the scope of the present invention is not limited to these embodiments, and various modifications can be made without departing from the gist of the present invention.

Examples of the polyolefin resin selected from ethylene/α-olefin copolymers, the α-olefin being a polar monomer, include, besides the ethylene/vinyl acetate copolymers described above, ethylene/ethyl acrylate copolymers, ethylene/butyl acrylate copolymers, and ethylene/methyl acrylate copolymers.

The polyolefin resin may contain other polyolefin resins such as low-density polyethylene, linear low-density polyethylene, high-density polyethylene, and polypropylene within a range that does not impair the gist of the present invention.

The amount of antimony trioxide, which may be added in order to impart flame retardancy to the resin composition, is preferably in the range of 1% to 30% by mass relative to the total of the mass of chlorinated polyethylene and the polyolefin resin. When the amount of antimony trioxide added exceeds 30% by mass, a tensile strength, a tensile elongation at break, and the like are decreased and the mechanical strength becomes insufficient. Furthermore, heat resistance becomes insufficient, and the effects aimed by the present invention are not obtained. Flexibility is also decreased.

Examples of the flame retardant other than antimony trioxide include bromine-based flame retardants; and metal hydroxides such as magnesium hydroxide, aluminum hydroxide, and calcium hydroxide. Examples of the filler include metal oxides such as magnesium oxide, calcium oxide, and titanium oxide; carbonates such as magnesium carbonate, aluminum carbonate, calcium carbonate, and barium carbonate; silicates such as magnesium silicate, calcium silicate, sodium silicate, and aluminum silicate; sulfates such as aluminum sulfate, calcium sulfate, and barium sulfate; carbon black; and talc.

Examples of the antioxidant include phenol-based antioxidants, amine-based antioxidants, sulfur-based antioxidants, and phosphorus-based antioxidants. Examples of the lubricant include stearic acid, fatty acid amides, silicones, and polyethylene waxes. These additives may be incorporated alone or in combination.

### Examples

Chlorinated polyethylene, a polyolefin resin, zeolite, and hydrotalcite used in Examples and Comparative Examples are described below. Resin compositions of Examples and Comparative Examples further contain antimony trioxide (manufactured by Nihon Seiko Co., Ltd.) serving as a flame retardant, calcium carbonate (trade name: KS 1000, manufactured by Calfine Co., Ltd.) serving as an extender, a phenol-based antioxidant (trade name: Irganox 1010, manufactured by Ciba Specialty Chemicals Inc.), and stearic acid (manufactured by NOF Corporation) serving as a lubricant.

### [Chlorinated Polyethylene]

ELASLEN 252B (trade name, manufactured by Showa Denko K.K.)

### [Polyolefin Resin]

EVAFLEX EV360 (trade name, manufactured by Du pont-Mitsui Polychemicals Co., Ltd, EVA)

### [Zeolite]

MIZUKALIZER RAD-P (trade name, manufactured by Mizusawa Industrial Chemicals, Ltd., synthetic active zeolite (main components: Al, Si, Ca, and Mg))

### [Hydrotalcite]

DHT-4A (trade name, manufactured by Kyowa Chemical Industry Co., Ltd., synthetic hydrotalcite)

The composition shown in Table I was kneaded with an open roll mill at 140° C., and the kneaded material was then pressed at 140° C. and 600 MPa for 10 minutes to prepare a sheet-like sample having a thickness of 1 mm. The remaining material was pelletized with a pelletizer. The prepared pellets were extruded using a 50 mm-φ extruder to form a tube having an inner diameter φ of 3 mm and an outer diameter φ of 4 mm. The sheet and the tube were irradiated with an electron beam of 200 kGy to prepare cross-linked products. For the tube, a tensile strength at break, a tensile elongation at break, flexibility, heat resistance, and oil resistance were evaluated. For the sheet, flame retardancy and processability were evaluated. The results are summarized in Table I. The evaluation methods are as follows.

### (Tensile Strength at Break and Tensile Elongation at Break)

A tube of 120 mm was cut, and a tensile strength at break and a tensile elongation at break (represented by “tensile strength” and “tensile elongation”, respectively, in the table, and this also applies to measurement items described below) of the tube were measured at a tensile speed of 500 mm/min. Regarding the criteria of acceptable and unacceptable levels, a tube having a tensile strength at break of 10.4 MPa or more was determined to be acceptable, and a tube having a tensile elongation at break of 225% or more was determined to be acceptable.

### (Flexibility)

In the measurement of the tensile strength at break and the tensile elongation at break, a modulus when the tube was elongated by 100% was read from an S—S curve. When the value of the modulus was less than 10 MPa, the tube was determined to be acceptable.

### (Heat Resistance)

A tube of 120 mm was cut, and placed in a Geer oven at 121° C. for seven days. The tube was then taken out, and a tensile strength at break and a tensile elongation at break of the tube were measured at a tensile speed of 500 mm/min. Regarding the criteria of acceptable and unacceptable levels, a tube having a tensile strength at break of 8.3 MPa or more was determined to be acceptable, and a tube having a tensile elongation at break of 175% or more was determined to be acceptable.

(Oil resistance)

A tube of 120 mm was cut, and immersed in MIL-H-5606, which is a hydraulic oil that meets the MIL standard, at room temperature for one day. A tensile strength at break and a tensile elongation at break of the tube were then measured at a tensile speed of 500 mm/min. Regarding the criteria of acceptable and unacceptable levels, a tube having a tensile strength at break of 6.9 MPa or more was determined to be acceptable, and a tube having a tensile elongation at break of 175% or more was determined to be acceptable.

### (Flame Retardancy)

Flame retardancy was evaluated by the UL94 flammability test. The level of V-2 or higher was determined to be acceptable.

### (Processability)

A resin composition was pressed at 200° C. and 600 MPa for 10 minutes, and the occurrence of foaming was examined by visual observation. When foaming was not observed, the sample was determined to be acceptable and represented by “A” in the table. When foaming was observed, the sample was represented by “B” in the table.

TABLE I

| | | | | | Comparative | Comparative |
|---|---|---|---|---|---|---|
| Material | | Example 1 | Example 2 | Example 3 | Example 1 | Example 2 |
| ELASLEN 252B (chlorinated | | 100 | 100 | 82 | 100 | 100 |
| polyethylene) | | | | | | |
| EVAFLEX EV360 (EVA) | | — | — | 18 | — | — |
| MIZUKALIZER RAD-P | | 1 | 18 | 1 | — | 22 |
| DHT-4A | | — | — | — | 1 | — |
| Antimony trioxide (flame retardant) | | 10 | 10 | 10 | 10 | 10 |
| KS1000 | | 10 | 10 | 10 | 10 | 10 |
| Irganox 1010 (antioxidant) | | 1 | 1 | 1 | 1 | 1 |
| Stearic acid (lubricant) | | 1 | 1 | 1 | 1 | 1 |
| Tensile | Standard > 10.4 MPa | 14.1 | 10.8 | 13.2 | 12.5 | 9.8 |
| strength | | | | | | |
| MPa | | | | | | |
| Tensile | Standard > 225% | 290 | 240 | 300 | 260 | 230 |
| elongation | | | | | | |
| % | | | | | | |

| 100% modulus (MPa) | | Standard < | 8.1 | 9.5 | 8.5 | 8.2 | 9.8 |
|---|---|---|---|---|---|---|---|
| | | 10 MPa | | | | | |
| Heat | Tensile | Standard > | 12.1 | 10.2 | 13.2 | 10.5 | 9.2 |
| resistance | strength | 8.3 MPa | | | | | |
| | MPa | | | | | | |
| | Tensile | Standard > | 220 | 230 | 240 | 130 | 230 |
| | elongation | 175% | | | | | |
| | % | | | | | | |
| Oil | Tensile | Standard > | 10.5 | 8.5 | 9.1 | 5.4 | 8.2 |
| resistance | strength | 6.9 MPa | | | | | |
| | MPa | | | | | | |
| | Tensile | Standard > | 200 | 190 | 210 | 190 | 185 |
| | elongation | 175% | | | | | |
| | % | | | | | | |

| | | | | | | |
|---|---|---|---|---|---|---|
| UL 94 flammability | Standard: V-2 or | V-2 | V-2 | V-2 | V-2 | V-2 |
| test | higher | | | | | |

| | | | | | | |
|---|---|---|---|---|---|---|
| Processability (pressed at | Standard: | A | A | A | B | A |
| 200° C. for 10 minutes, | Foaming | | | | | |
| 600 MPa) | is not | | | | | |
| | observed. | | | | | |

| | | | | | |
|---|---|---|---|---|---|
| Electron beam irradiation (kGy) | 200 | 200 | 200 | 200 | 200 |

Referring to the results shown in Table I, the flame-retardant, flexible resin compositions of the present invention (Examples 1 to 3), in which 1% to 18% by mass of a zeolite-based compound (synthetic active zeolite) was blended with chlorinated polyethylene, provided formed products having high mechanical strengths (tensile strength and tensile elongation) and flexibility (100% modulus) and exhibited good processability without foaming during processing. Furthermore, formed products that satisfy the standards of heat resistance, oil resistance, and flame retardancy were also obtained.

In Example 3, in which EVA (EVAFLEX EV360: a polyolefin resin selected from ethylene/α-olefin copolymers, the α-olefin being a polar monomer) was blended in an amount of 18 parts by mass relative to 100 parts by mass of the total of the chlorinated polyethylene and the polyolefin resin, heat resistance higher than that of Example 1 (having the same composition except for the polyolefin resin) was obtained.

In contrast, in Comparative Example 1, in which hydrotalcite was used instead of the zeolite-based compound, although the other conditions were the same, foaming was observed under the conditions of the processing, which showed poor processability. The resulting formed product did not satisfy the standard of the tensile elongation regarding heat resistance, and did not satisfy the standard of the tensile strength regarding oil resistance. It is believed that this is because hydrotalcite does not sufficiently adsorb hydrochloric acid gas generated from the chlorinated polyethylene.

In Comparative Example 2, in which the amount of zeolite-based compound blended was 22% by mass relative to the amount of chlorinated polyethylene, the tensile strength did not satisfy the standard.

1. A flame-retardant, flexible resin composition comprising a resin component that mainly contains chlorinated polyethylene; and 0.5 to 20 parts by mass of a zeolite-based compound relative to 100 parts by mass of the chlorinated polyethylene, the resin composition being cross-linked by irradiation with ionizing radiation.

2. The flame-retardant, flexible resin composition according to claim 1, wherein the zeolite-based compound is a synthetic zeolite represented by a general formula M_{2/x}O.Al₂O₃.ySiO₂.nH₂O (where M represents an alkaline earth metal, x represents 1 or 2, y represents 2 to 10, and n represents zero or a positive number).

3. The flame-retardant, flexible resin composition according to claim 2, wherein the zeolite-based compound is a calcined zeolite.

4. The flame-retardant, flexible resin composition according to claim 1, wherein the resin component further contains a polyolefin resin selected from ethylene/α-olefin copolymers, the α-olefin being a polar monomer, in an amount of 20 parts by mass or less relative to 100 parts by mass of the total of the chlorinated polyethylene and the polyolefin resin.

5. A resin tube produced by forming the flame-retardant, flexible resin composition according to claim 1 into a tube.

6. An insulated wire comprising an insulating coating composed of the flame-retardant, flexible resin composition according to claim 1.
